(19) United States
(12) Patent Application Publication
(10) Pub. No.: US 2026/0331986 A1
(43) Pub. Date: Oct. 22, 2026

(54) INSULATING PAPER

(71) Applicant: FANUC CORPORATION, Minamitsuru-gun, Yamanashi (JP)

(72) Inventor: Yuuta KONDOU, Yamanashi (JP)

(73) Assignee: FANUC CORPORATION, Minamitsuru-gun, Yamanashi (JP)

(21) Appl. No.: 19/108,691

(22) PCT Filed: Oct. 18, 2022
(86) PCT No.: PCT/JP2022/038784

§ 371 Date: Mar. 4, 2025

(51) Int. Cl. H02K 3/38; H02K 1/16; H02K 3/30

(52) U.S. Cl. CPC H02K 3/38; H02K 1/16; H02K 3/30

(57) ABSTRACT

This insulating paper insulates between different phases of coil ends of coils provided to a stator core of an electric motor, the insulating paper comprising an upper side part positioned on the upper side, a lower side part positioned on the lower side, a left side part that connects the left end of the upper side part and the left end of the lower side part, and a right side part that connects the right end of the upper side part and the right end of the lower side part. The upper side part bulges upward to a greater extent with progression in a direction mutually approaching from both the left and right end parts. The lower side part has a first side part that extends rightward from the left side part, and a second side part that inclines upward to a greater extent with progression rightward from the right end of the first side part and is connected to the right side part. The angle formed between the lower side part and the left side part is acute.

### TECHNICAL FIELD

The present disclosure relates to an insulating paper that provides insulation between different phases of coil ends of an electric motor.

### BACKGROUND ART

Typically, an insulating paper is used to provide insulation between coil ends in different phases in an electric motor. The insulating paper is inserted between the coil ends at a location where the coil ends are in contact with each other. By inserting the insulating paper between the coil ends, the withstand voltage can be increased. In the related art, various insulating papers for use in electric motors have been proposed. For example, two kinds of insulating papers with different shapes may be used to provide insulation between different phases of coil ends.

### Citation List

### Patent Document

Patent Document 1: Japanese Unexamined Patent Application, Publication No.2004-112974

### DISCLOSURE OF THE INVENTION

### Problems to Be Solved by the Invention

In the case where two kinds of insulating papers are used, one of the insulating papers is inserted between the coil ends, the other insulating paper is then inserted between the coil ends, and this work takes time and effort. In the case where two kinds of insulating papers are used, there is a concern that, in a state where the two kinds of insulating papers have been inserted between the coil ends, a location that requires insulation cannot entirely be insulated in a complementary manner due to one kind of or both the insulating papers being not appropriately disposed. In the case where two kinds of insulating papers are used, in a state where the two kinds of insulating papers have been inserted between the coil ends, since the two kinds of insulating papers overlap with each other, it is difficult to visually check whether the location to be insulated is properly insulated.

Typically, in a case where a dimension requirement of coil ends of an electric motor is strict, a correcting process of correcting a coil end shape through pressing or by strongly hitting the coil ends is performed in the manufacturing. The coil ends subjected to the correcting process are not suitable for the insertion of the insulating papers since the coils are in tight contact with each other, and for this reason, the insertion of the insulating papers is thus performed prior to the correcting process. When the correcting process is performed, the coil ends have two kinds of insulating papers inserted therebetween. The two kinds of insulating papers inserted between the coil ends are in a greatly warped state such that the location to be insulated can be insulated. When the insulating papers inserted between the coil ends are greatly warped, the likelihood of displacement of the insulating papers due to deformation and movement of the coils during the correcting process becomes high. In this case, there may be a problem in that it is not possible to insulate the location to be insulated due to displacement of one of or both the two kinds of insulating papers from proper positions.

Therefore, a checking process of checking whether the location to be insulated is properly insulated is performed after the correcting process. In the case of using two kinds of insulating papers, it is difficult to visually check whether insulation has been provided between coil ends, as described above. Therefore, the checking process requires time and effort. A position correcting process of correcting the positions of the two kinds of insulating papers is performed at a location where insulation has not properly been provided after the checking process. In the position correcting process, the positions of the two kinds of insulating papers are corrected, and the correction thus takes time and effort.

As described above, there have been various problems in the related art. Thus, in order to solve these problems, there has been a demand for an insulating paper that can be easily inserted between coil ends in different phases and can be easily adjusted in position in a state of being inserted between the coil ends, and that makes it easy to know whether or not insulation has been successfully provided from appearance.

### Means for Solving the Problems

An insulating paper according to the present disclosure provides insulation between different phases of coil ends of coils installed in a stator core of an electric motor, the insulating paper including: an upper side part located on an upper side; a lower side part located on a lower side; a left side part connecting a left end of the upper side part and a left end of the lower side part; and a right side part connecting a right end of the upper side part and a right end of the lower side part. The upper side part bulges upward to a greater extent with progression in a direction mutually approaching from both left and right end parts. The lower side part includes a first side part extending rightward from the left side part and a second side part joined to the right side part, the second side part being inclined upward to a greater extent with progression rightward from a right end of the first side part. An angle formed between the lower side part and the left side part is acute.

### BRIEF DESCRIPTION OF THE DRAWINGS

FIG. 1 is a front view illustrating an insulating paper according to a first embodiment of the present invention;

FIG. 2 is a schematic perspective view illustrating a state of use of the insulating paper according to the first embodiment of the present invention and illustrates a state seen from outside of a stator;

FIG. 3 is a schematic perspective view illustrating a state of use of the insulating paper according to the first embodiment of the present invention and illustrates a state seen from inside of the stator;

FIG. 4 is a front view illustrating the insulating paper according to the first embodiment of the present invention and illustrates a folded position when the insulating paper is used;

FIG. 5 is a schematic perspective view illustrating a state of use of the insulating paper according to the first embodiment of the present invention and illustrates a positional relationship between the insulating paper and locations to be insulated;

FIG. 6 is a front view illustrating an insulating paper according to a second embodiment of the present invention;

FIG. 7 is a front view illustrating an insulating paper according to a third embodiment of the present invention;

FIG. 8 is a front view illustrating an insulating paper according to a fourth embodiment of the present invention; and

FIG. 9 is a front view illustrating an insulating paper according to a fifth embodiment of the present invention.

### PREFERRED MODE FOR CARRYING OUT THE INVENTION

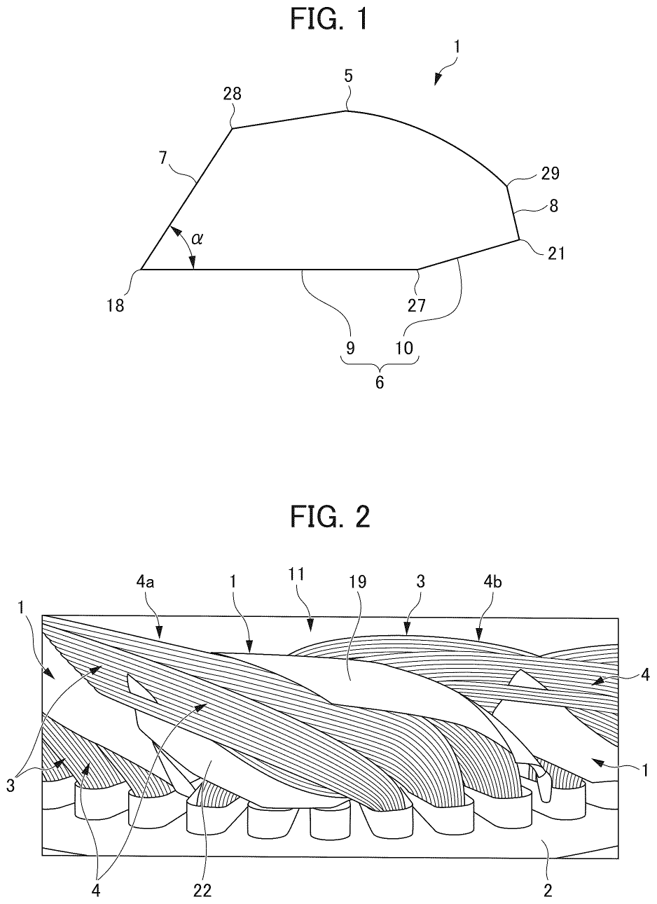

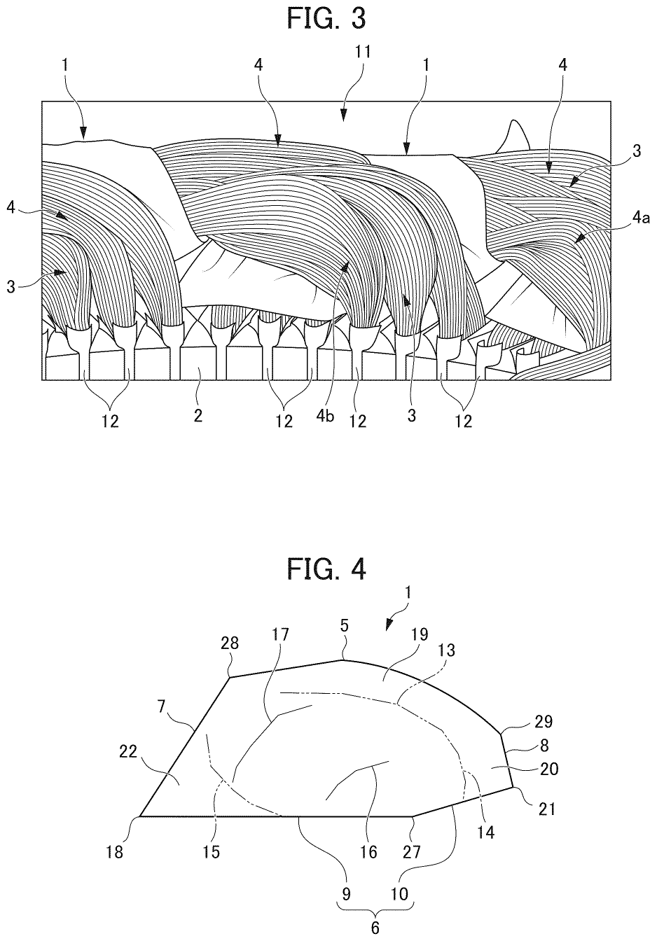

Hereinafter, an insulating paper according to an aspect of the present disclosure will be described with reference to the drawings. An insulating paper 1 according to a first embodiment will be described with reference to FIGS. 1 to 5. The insulating paper 1 provides insulation between different phases of coil ends 4 of a coil 3 provided in a stator core 2 of an electric motor. Here, “insulation” described in the present application means electrical insulation. A material of the insulating paper 1 is not particularly limited as long as it is possible to provide insulation between the coil ends 4 and 4 in different phases with the material. As illustrated in FIG. 1, the insulating paper 1 has a sheet shape and includes an upper side part 5 located on the upper side, a lower side part 6 located on the lower side, a left side part 7 connecting a left end of the upper side part 5 and a left end of the lower side part 6, and a right side part 8 connecting a right end of the upper side part 5 and a right end of the lower side part 6.

The upper side part 5 bulges upward to a greater extent with progression in a direction mutually approaching from both left and right end parts. In the illustrated example, the upper side part 5 has a curved shape bulging upward in an arc shape. The upper side part 5 connects an upper end of the left side part 7 and an upper end of the right side part 8. In other words, a left end of the upper side part 5 is joined to the upper end of the left side part 7 (the joined location between the upper side part 5 and the left side part 7 is denoted by a reference sign 28), and a right end of the upper side part 5 is joined to the upper end of the right side part 8 (the joined location between the upper side part 5 and the right side part 8 is denoted by a reference sign 29). In the illustrated example, the upper end (joined location 28) of the left side part 7 is located on the side further upward than the upper end (joined location 29) of the right side part 8.

The lower side part 6 includes a first side part 9 with a straight line shape and a second side part 10 with a straight line shape. The first side part 9 extends rightward from a lower end of the left side part 7. In other words, a left end of the first side part 9 is joined to the lower end of the left side part 7 (a corner part that is a joined location between the first side part 9 and the left side part 7 is denoted by a reference sign 18). In the illustrated example, the first side part 9 extends rightward from the left side part 7 so as to follow the horizontal direction. The second side part 10 is inclined upward to a greater extent with progression rightward from a right end of the first side part 9. The second side part 10 connects the right end of the first side part 9 and a lower end of the right side part 8. In other words, a left end of the second side part 10 is joined to the right end of the first side part 9 (a corner part that is a joined location between the first side part 9 and the second side part 10 is denoted by a reference sign 27), and a right end of the second side part 10 is joined to the lower end of the right side part 8 (a corner part that is a joined location between the second side part 10 and the right side part 8 is denoted by a reference sign 21). The length of the second side part 10 is shorter than the length of the first side part 9.

The left side part 7 has a straight line shape. The upper end of the left side part 7 is joined to the left end of the upper side part 5, and the lower end of the left side part 7 is joined to the left end of the first side part 9. The left side part 7 is inclined rightward to a greater extent with progression upward from the left end of the first side part 9. Specifically, an angle a formed between the first side part 9 of the lower side part 6 and the left side part 7 is acute.

The right side part 8 has a straight line shape. The upper end of the right side part 8 is joined to the right end of the upper side part 5, and the lower end of the right side part 8 is joined to the right end of the second side part 10. The right side part 8 is inclined leftward to a greater extent with progression upward from the right end of the second side part 10.

Note that the first side part 9 of the lower side part 6, the second side part 10 of the lower side part 6, the left side part 7, and the right side part 8 are not limited to the straight line shapes and may partially or entirely have curved shapes. In other words, in the present application, the “side parts” include a case of straight line shapes, a case of curved shapes, and a case including both the straight line shapes and curved shapes, in regard to the first side part 9 of the lower side part 6, the second side part 10 of the lower side part 6, the left side part 7, and the right side part 8.

The insulating paper 1 with such a configuration is inserted between the coil ends 4 and 4 in different phases. As illustrated in FIGS. 2, 3, and 5, the stator 11 is used with a rotor, which is not illustrated, in an electric motor that gives power to a rotating device. The stator 11 includes a cylindrical stator core 2 and a plurality of coils 3 provided in the stator core 2.

The stator core 2 has a cylindrical shape with both end parts in an axis direction opened and is made of a magnetic material. The stator core 2 includes a plurality of slots 12. The plurality of slots 12 are disposed inside the stator core 2 in an aligned manner in a circumferential direction of the stator core 2.

The plurality of coils 3 are inserted into the slots 12 of the stator core 2. Each coil 3 projects outward from one end surface of the stator core 2 in the axis direction and projects outward from the other end surface of the stator core 2 in the axis direction in a state where the coil 3 is inserted into the slots 12. In this manner, the coil 3 has the coil ends 4 projecting outward from both the end surfaces of the stator core 2 in the axis direction.

In the illustrated example, the coils 3 in three phases, namely a U phase, a V phase, and a W phase are inserted into the slots 12 of the stator core 2. For example, the coils 3 in the three phases are inserted into the slots 12 such that the coils 3 in different phases are disposed in every three slots. In a case where one phase is configured by three slots in this manner, the coil ends 4 and 4 in different phases intersect each other in the same manner in every six slots. Therefore, a part corresponding to six slots of the stator core 2 is illustrated in FIGS. 2, 3, and 5 for convenience of explanation.

At the portion where the coil ends 4 and 4 in different phases intersect each other, the insulating paper 1 is inserted between a coil end 4a on the outer side and a coil end 4b on the inner side. The insulating paper 1 is appropriately folded along outer shapes of the coil end 4a on the outer side and the coil end 4b on the inner side in a state where the insulating paper 1 is disposed between the coil end 4a on the outer side and the coil end 4b on the inner side. As illustrated in FIG. 4, the insulating paper 1 is folded at a first folded position 13, a second folded position 14, a third folded position 15, a fourth folded position 16, and a fifth folded position 17.

The first folded position 13 is located with a gap from the upper side part 5. The first folded position 13 has a substantially curved shape along the upper side part 5. In other words, the distance between the first folded position 13 and the upper side part 5 is substantially constant at the portion between the first folded position 13 and the upper side part 5. The second folded position 14 is located with a gap from the right side part 8. The second folded position 14 smoothly continues from the first folded position 13. The second folded position 14 extends from the first folded position 13 to the second side part 10 of the lower side part 6. The distance between the second folded position 14 and the right side part 8 is longer than the distance between the first folded position 13 and the upper side part 5 at the portion between the second folded position 14 and the right side part 8. The third folded position 15 is located with a gap from the corner part 18 between the left side part 7 and the first side part 9 of the lower side part 6. The third folded position 15 extends to connect the left side part 7 and the first side part 9. The portion surrounded by the third folded position 15, the left side part 7, and the first side part 9 has a substantially triangular shape.

The fourth folded position 16 is located between the first folded position 13 and the third folded position 15. The fourth folded position 16 extends to be inclined rightward to a greater extent with progression upward. The fifth folded position 17 is located between the first folded position 13 and the third folded position 15. The fifth folded position 17 is located on the side further leftward than the fourth folded position 16. The fifth folded position 17 extends to be inclined rightward to a greater extent with progression upward.

If the portion between the first folded position 13 and the upper side part 5 is defined as a first region 19, the first region 19 includes the upper side part 5. If the portion between the second folded position 14 and the right side part 8 is defined as a second region 20, the second region 20 includes the corner part 21 between the right side part 8 and the second side part 10 since the second folded position 14 reaches the second side part 10. The second region 20 continues from the first region 19. If the portion surrounded by the third folded position 15, the left side part 7, and the first side part 9 is defined as a third region 22, the third region 22 includes the corner part 18 between the left side part 7 and the first side part 9. In this manner, the insulating paper 1 includes the first region 19, the second region 20, and the third region 22.

As illustrated in FIGS. 2, 3, and 5, the first region 19 is folded outside the stator core 2 along an upper part of the coil end 4a on the outer side in the state where the insulating paper 1 is disposed between the coil end 4b on the inner side and the coil end 4a on the outer side. The second region 20 is folded outside the stator core 2 along a root portion of the coil end 4a on the outer side in the state where the insulating paper 1 is disposed between the coil end 4b on the inner side and the coil end 4a on the outer side. The third region 22 is folded outside the stator core 2 along a lower portion of the coil end 4a on the outer side and the root portion of the coil end 4a on the outer side in the state where the insulating paper 1 is disposed between the coil end 4b on the inner side and the coil end 4a on the outer side. A tip end part of the folded third region 22 is inserted into the coil end 4a on the outer side. Since the coil end 4a on the outer side is configured of a plurality of windings, it is possible to insert the tip end part of the third region 22 into the coil end 4a on the outer side.

The first folded position 13, the second folded position 14, and the third folded position 15 are formed by folding the insulating paper 1 along the outer shape of the coil end 4a on the outer side. In other words, the first folded position 13, the second folded position 14, and the third folded position 15 are not formed in advance in the insulating paper 1 and are formed by folding the insulating paper 1 along the coil end 4a on the outer side.

Note that the root portion of the coil end 4a to be followed when the third region 22 is folded is located on the side opposite to the root portion of the coil end 4a to be followed when the second region 20 is folded. In the illustrated example, the second region 20 is folded along the root portion of the coil end 4a standing up from the slot 12 on one end side from among three slots, and the third region 22 is folded along the root portion of the coil end 4a standing up from the slot 12 on the other end side from among the three slots.

In this manner, the insulating paper 1 wraps the coil end 4a on the outer side from a right upper portion of the coil end 4a on the outer side and wraps the coil end 4a on the outer side from a left lower portion of the coil end 4a on the outer side. The insulating paper 1 is thus disposed between the coil end 4a on the outer side and the coil end 4b on the inner side such that the coil end 4a on the outer side is sandwiched. Therefore, the insulating paper 1 is unlikely to be displaced with respect to the coil end 4a on the outer side and the coil end 4b on the inner side in an insulated state. The insulating paper 1 is disposed to provide insulation between the coil end 4a on the outer side and the coil end 4b on the inner side, and the tip end part of the third region 22 inserted into the coil end 4a on the outer side and the corner part 21 between the right side part 8 and the second side part 10 are then cut off.

In the state where the insulating paper 1 wraps the coil end 4a on the outer side, the insulating paper 1 is folded inside the stator core 2 to follow the outer shape of the coil end 4b on the inner side. The fourth folded position 16 and the fifth folded position 17 are formed by the insulating paper 1 being folded inside the stator core 2. In other words, the fourth folded position 16 and the fifth folded position 17 are not formed in advance in the insulating paper 1 and are formed by folding the insulating paper 1 along the coil end 4b on the inner side.

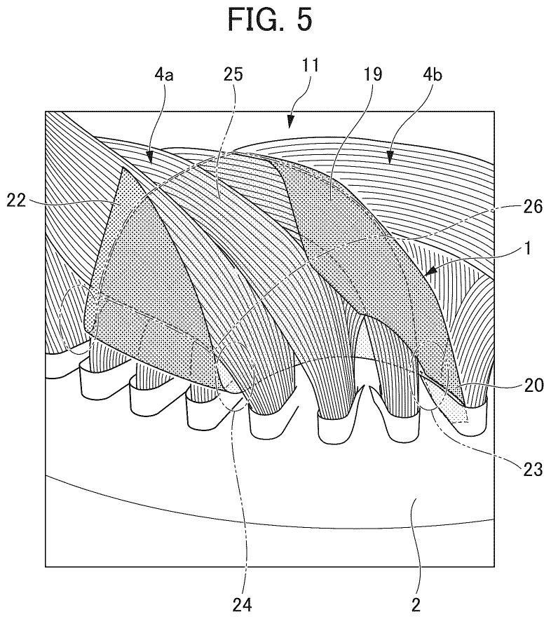

It is possible to insulate locations to be insulated by wrapping the coil end 4a on the outer side with the insulating paper 1. As illustrated in FIG. 5, the locations to be insulated are a first location to be insulated 23, a second location to be insulated 24, and a third location to be insulated 25. The first location to be insulated 23 is between the root portion of the coil end 4a on the outer side on one end side in a width direction and the root portion of the coil end 4 adjacent thereto. The second location to be insulated 24 is between the root portion of the coil end 4a on the outer side on the other end side in the width direction and the root portion of the coil end 4 adjacent thereto. The third location to be insulated 25 is a portion where the coil end 4a on the outer side and the coil end 4b on the inner side intersect each other.

If the second region 20 is folded, then the root portion of the coil end 4a on the outer side is wrapped with a lower portion of the right end part of the insulating paper 1, and it is thus possible to insulate the first location to be insulated 23. If the third region 22 is folded, then the root portion of the coil end 4a on the outer side is wrapped with a lower portion of the insulating paper 1, and it is thus possible to insulate the second location to be insulated 24. The third location to be insulated 25 is covered with a left portion of an upper portion of the insulating paper 1 and can thus be insulated. When the third location to be insulated 25 is insulated, it is possible to cause the insulating paper 1 to follow the shape of the third location to be insulated 25 by folding the right portion of the first region 19 to correspond to a corner part 26 of the third location to be insulated 25. Also, it is possible to draw the insulating paper 1 into the root portion of the coil end 4a on the outer side.

In the case of the insulating paper 1 according to the first embodiment, the first folded position 13 with a curved shape is formed by folding the first region 19 along the coil end 4a on the outer side. In other words, the first region 19 is folded along the first folded position 13. The distance between the upper side part 5 and the first folded position 13 of the first region 19 has a length that allows the coil end 4a on the outer side to be covered in the first region 19. In this case, it is possible to shorten the distance between the upper side part 5 and the first folded position 13 while securing the distance between the upper side part 5 and the first folded position 13 by forming the upper side part 5 in an arc shape. It is thus possible to suppress warping of the first region 19 when the first region 19 is folded. Therefore, according to the insulating paper 1 of the first embodiment, the upper side part 5 has an arc shape following the first folded position 13, and the first region 19 is thus easily folded along the coil end 4a on the outer side.

In the case of the insulating paper 1 according to the first embodiment, the fourth folded position 16 is formed by the insulating paper 1 being folded inward along the coil end 4b on the inner side. In other words, the insulating paper 1 is folded along the fourth folded position 16. In the case of the insulating paper 1 according to the first embodiment, the second folded position 14 is formed by the second region 20 being folded along the coil end 4a on the outer side. In other words, the second region 20 is folded along the second folded position 14. The corner part 21 between the right side part 8 and the second side part 10 is located on the side further downward as compared with that before the insulating paper 1 is folded by the insulating paper 1 being folded inward along the fourth folded position 16 and by the second region 20 being folded outward along the second folded position 14.

A comparative example in a case where the lower side part of the insulating paper has a straight line shape will be described. In this case, if the insulating paper is folded inward along the fourth folded position and the second region is folded outward along the second folded position, the corner part between the right side part and the lower side part is located on the side further downward as compared with the case where the insulating paper includes the second side part. Therefore, in the case of the insulating paper in the comparative example, the corner part between the right side part and the lower side part is brought into contact with the stator core 2 in a state where the insulating paper provides insulation between the coil end 4a on the outer side and the coil end 4b on the inner side. According to the insulating paper in the comparative example, the corner part between the right side part and the lower side part is brought into contact with the stator core 2, and it is thus not possible to draw the insulating paper on the root side of the coil end 4a on the outer side.

On the contrary, the aforementioned problem is unlikely to occur in the insulating paper 1 according to the first embodiment since the insulating paper 1 includes the second side part 10. Thus, in the case of the insulating paper 1 according to the first embodiment, it is possible to draw the corner part 21 between the right side part 8 and the second side part 10 on the root side of the coil end 4a on the outer side. Therefore, according to the insulating paper 1 of the first embodiment, it is possible to sufficiently insulate the root portion of the coil end 4a on the outer side.

In the case of the insulating paper 1 according to the first embodiment, the distance between the second folded position 14 and the right side part 8 at the part between the second folded position 14 and the right side part 8 is longer than the distance between the first folded position 13 and the upper side part 5. In other words, the width of the second region 20 is wider than the width of the first region 19. Therefore, according to the insulating paper 1 of the first embodiment, it is possible to sufficiently protect the root portion of the coil end 4a on the outer side. According to the insulating paper 1 of the first embodiment, the second region 20 has a wider width than the first region 19 and is thus easily held when used as a handle during the work of inserting the insulating paper 1 between the coil end 4a on the outer side and the coil end 4b on the inner side.

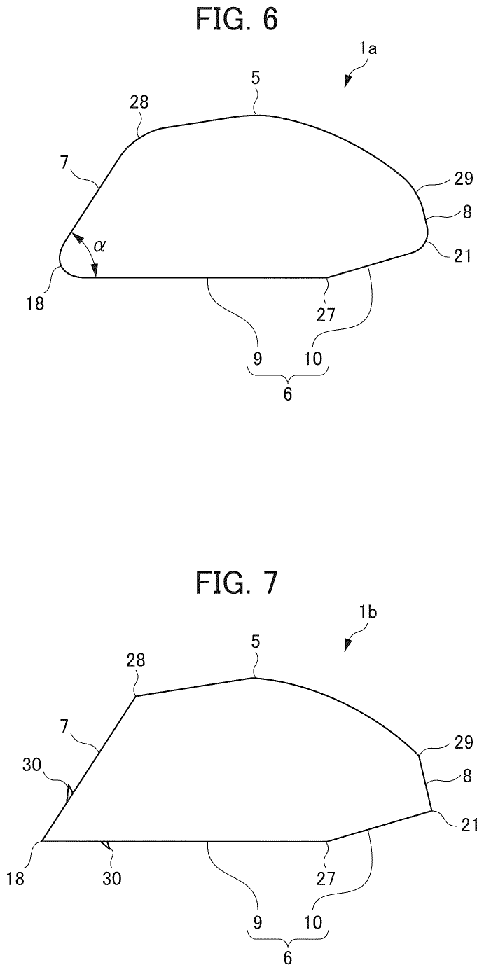

Next, an insulating paper according to a second embodiment of the present invention will be described using FIG. 6. Note that components with the same reference signs as the reference signs applied in the first embodiment have the same effects and description thereof may thus be omitted below. An insulating paper 1a according to the second embodiment is different from the insulating paper according to the first embodiment in that the insulating paper 1a has a rounded shape as a whole.

In the insulating paper 1a, a corner part 18 between a left side part 7 and a first side part 9 has a round shape. A corner part 27 between the first side part 9 and a second side part 10 has a round shape. A corner part 21 between the second side part 10 and a right side part 8 has a round shape. The term “round shape” described in the present application means a rounded shape with an outline configured of a curved line. In the case where the corner part 18 between the left side part 7 and the first side part 9 has a round shape, an angle at a portion where an extended line of the left side part 7 and an extended line of the first side part 9 intersect each other is α. In the insulating paper 1a, a joined location 28 between the left side part 7 and an upper side part 5 has a curved shape bulging outward. In this manner, the left side part 7 and the upper side part 5 smoothly continue from each other. A joined location 29 between a right side part 8 and the upper side part 5 has a curved shape bulging outward. In this manner, the right side part 8 and the upper side part 5 smoothly continue from each other. Therefore, according to the insulating paper 1a of the second embodiment, it is possible to achieve the insulating paper 1a with a compact size.

Next, an insulating paper according to a third embodiment of the present invention will be described using FIG. 7. Note that components with the same reference signs as the reference signs applied in the first embodiment have the same effects and description thereof may thus be omitted below. An insulating paper 1b according to the third embodiment is different from the insulating paper according to the first embodiment in a configuration of a third region 22.

The insulating paper 1b includes suppressing parts 30 capable of suppressing displacement of the third region 22 in a state of being inserted into a coil end 4a on the outer side. In the illustrated example, the suppressing parts 30 have a substantially triangular shape and are provided at a left side part 7 and a first side part 9. The suppressing part 30 provided at the left side part 7 projects outward from the left side part 7. The suppressing part 30 provided at the first side part 9 projects outward from the first side part 9. With such a configuration, the third region 22 is unlikely to be displaced since the suppressing parts 30 get caught on windings in a state where the third region 22 is inserted into a coil end 4a on the outer side. Therefore, according to the insulating paper 1b of the third embodiment, it is possible to more reliably maintain a posture in an insulated state.

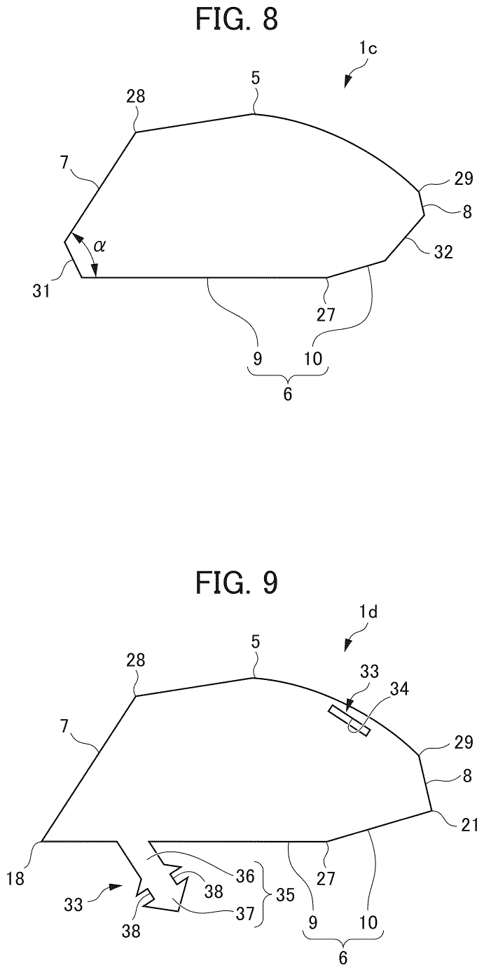

Next, an insulating paper according to a fourth embodiment of the present invention will be described using FIG. 8. Note that components with the same reference signs as the reference signs applied in the first embodiment have the same effects and description thereof may thus be omitted below. An insulating paper 1c according to the fourth embodiment is different from the insulating paper according to the first embodiment in a configuration of a lower portion.

In the insulating paper 1c, a left side part 7 and a first side part 9 are connected via first inclined side part 31 with a straight line shape. The first inclined side part 31 is inclined leftward to a greater extent with progression upward from the first side part 9. A lower end of the first inclined side part 31 is joined to a left end of the first side part 9. An upper end of the first inclined side part 31 is joined to a lower end of the left side part 7. An angle at a portion where an extended line of the left side part 7 and an extended line of the first side part 9 intersect each other is α. In the insulating paper 1c, a right side part 8 and a second side part 10 are connected via a second inclined side part 32 with a straight line shape. The second inclined side part 32 is inclined rightward to a greater extent with progression upward from the second side part 10. A lower end of the second inclined side part 32 is joined to a right end of the second side part 10. An upper end of the second inclined side part 32 is joined to a lower end of the right side part 8.

With such a configuration, it is not necessary to cut off a tip end part of a third region 22 and a corner part 21 between the right side part 8 and the second side part 10 after the insulating paper 1c is attached to a stator core 2. Therefore, according to the insulating paper 1c of the fourth embodiment, it is possible to improve workability when the insulating paper 1c is attached to the stator core 2.

Next, an insulating paper according to a fifth embodiment of the present invention will be described using FIG. 9. Note that components with the same reference signs as the reference signs applied in the first embodiment have the same effects and description thereof may thus be omitted below. An insulating paper 1d according to the fifth embodiment is different from the insulating paper according to the first embodiment in that the insulating paper 1d includes a restriction part 33 that restricts displacement from a posture in an insulated state.

The restriction part 33 includes an engaged part 34 and an engaging part 35 that is attachable to and detachable from the engaged part 34. The engaged part 34 is provided at a right portion in a first region 19. The engaged part 34 is a through-hole penetrating in a front-rear direction (thickness direction). The engaging part 35 is provided at a first side part 9. The engaging part 35 includes a projecting piece 36 projecting outward from the first side part 9 and an insertion piece 37 provided at a tip end part of the projecting piece 36. The insertion piece 37 includes recessed parts 38 at both end parts in a width direction. The width direction is a direction perpendicular to the direction in which the projecting piece 36 projects.

With such a configuration, the engaging part 35 is engaged with the engaged part 34 by inserting the insertion piece 37 of the engaging part 35 into the engaged part 34 in a state where the insulating paper 1d wraps a coil end 4a on the outer side. In the state where the insertion piece 37 is inserted into the engaged part 34, it is possible to prevent the engaging part 35 from falling off from the engaged part 34 by side walls of the recessed parts 38 of the insertion piece 37 on one side coming into contact with a rear surface of the insulating paper 1d.

In the case of the insulating paper 1d according to the fifth embodiment, the restriction part 33 is included, and it is thus possible to restrict displacement of the insulating paper 1d from the state where the insulating paper 1d wraps the coil end 4a on the outer side. Therefore, according to the insulating paper 1d of the fifth embodiment, it is possible to more reliably maintain the posture in the insulated state.

According to at least one of the embodiments described above, it is possible to provide insulation between the coil ends 4 and 4 with a single insulating paper 1 with the aforementioned configuration. Therefore, it is possible to provide an insulating paper 1 that can be easily inserted between the coil ends 4 and 4 in different phases and can be easily adjusted in position in a state of being inserted between the coil ends 4 and 4, and that makes it easy to know whether or not insulation has been successfully provided from appearance.

Although the present disclosure has been described in detail, the present disclosure is not limited to the aforementioned individual embodiments. Various additions, replacements, modifications, partial deletions, and the like can be made on these embodiments without departing from the gist of the present disclosure or without departing from the gist of the present disclosure derived from the content described in the claims and equivalents thereto. Moreover, these embodiments can also be implemented in combination. For example, the orders of the operations and the orders of treatments in the aforementioned embodiments are those illustrated as examples, and the present disclosure is not limited thereto. The same applies to cases where numerical values or expressions are used in the description of the aforementioned embodiments.

In regard to the aforementioned embodiments, the following supplements will be further disclosed.

### Supplement 1

An insulating paper (1) is an insulating paper that provides insulation between different phases of coil ends (4) of coils (3) installed in a stator core (2) of an electric motor, the insulating paper (1) including: an upper side part (5) located on an upper side; a lower side part (6) located on a lower side; a left side part (7) connecting a left end of the upper side part (5) and a left end of the lower side part (6) ; and a right side part (8) connecting a right end of the upper side part (5) and a right end of the lower side part (6). The upper side part (5) bulges upward to a greater extent with progression in a direction mutually approaching from both left and right end parts. The lower side part (6) includes a first side part (9) extending rightward from the left side part (7) and a second side part (10) joined to the right side part (8), the second side part (10) being inclined upward to a greater extent with progression rightward from a right end of the first side part (9). An angle (a) formed between the lower side part (6) and the left side part (7) is acute.

### Supplement

2

The insulating paper (1) preferably includes a first region (19) including the upper side part (5). In a state where the insulating paper (1) is disposed between a coil end (4b) on an inner side and a coil end (4a) on an outer side, the first region (19) is folded outward along an upper part of the coil end (4a) on the outer side.

### Supplement 3

The insulating paper (1) preferably includes a second region (20) including a corner part (21) between the right side part (8) and the second side part (10) and continuing from the first region (19). In a state where the insulating paper (1) is disposed between the coil end (4b) on the inner side and the coil end (4a) on the outer side, the second region (20) is folded outward along a root portion of the coil end (4a) on the outer side.

### Supplement 4

The insulating paper (1) preferably includes a third region (22) including a corner part (18) between the left side part (7) and the first side part (9). In a state where the insulating paper (1) is disposed between the coil end (4b) on the inner side and the coil end (4a) on the outer side, the third region (22) is folded outward along a lower portion of the coil end (4a) on the outer side and a root portion of the coil end (4a) on the outer side. A tip end part of the folded third region (22) is inserted into the coil end (4a) on the outer side.

### EXPLANATION OF REFERENCE NUMERALS

1 Insulating paper
2 Stator core
3 Coil
4 Coil end
4a Coil end on outer side
4b Coil end on inner side
5 Upper side part
6 Lower side part
7 Left side part
8 Right side part
9 First side part
10 Second side part
18 Corner part
19 First region
20 Second region
21 Corner part
22 Third region
α Angle

1. An insulating paper that provides insulation between different phases of coil ends of coils installed in a stator core of an electric motor, the insulating paper comprising:
an upper side part located on an upper side;
a lower side part located on a lower side;
a left side part connecting a left end of the upper side part and a left end of the lower side part; and
a right side part connecting a right end of the upper side part and a right end of the lower side part,
the upper side part bulging upward to a greater extent with progression in a direction mutually approaching from both left and right end parts,
the lower side part comprising a first side part extending rightward from the left side part and a second side part joined to the right side part, the second side part being inclined upward to a greater extent with progression rightward from a right end of the first side part,
an angle formed between the lower side part and the left side part being acute.

2. The insulating paper according to claim 1, wherein
the insulating paper comprises a first region including the upper side part, and
in a state where the insulating paper is disposed between a coil end on an inner side and a coil end on an outer side, the first region is folded outward along an upper portion of the coil end on the outer side.

3. The insulating paper according to claim 2, wherein
the insulating paper comprises a second region including a corner part between the right side part and the second side part and continuing from the first region, and
in a state where the insulating paper is disposed between the coil end on the inner side and the coil end on the outer side, the second region is folded outward along a root portion of the coil end on the outer side.

4. The insulating paper according to claim 2, wherein
the insulating paper comprises a third region including a corner part between the left side part and the first side part,
in a state where the insulating paper is disposed between the coil end on the inner side and the coil end on the outer side, the third region is folded outward along a lower portion of the coil end on the outer side and a root portion of the coil end on the outer side, and
a tip end part of the folded third region is inserted into the coil end on the outer side.
